(19) United States
(12) Patent Application Publication
(10) Pub. No.: US 2014/0151971 A1
(43) Pub. Date: Jun. 5, 2014

(54) ERGONOMIC TROLLEY HANDLE

(71) Applicants: Bradley Workman, Snellville, GA (US); David Jackson, Gainesville, GA (US); Mark Dorenkott, Westlake, OH (US); Arie Jusidman, Granada (MX)

(72) Inventors: Bradley Workman, Snellville, GA (US); David Jackson, Gainesville, GA (US); Mark Dorenkott, Westlake, OH (US); Arie Jusidman, Granada (MX)

(73) Assignee: TRUPER HERRAMIENTAS S.A. DE C.V, Colonia Granada (MX)

(21) Appl. No.: 13/705,201

(22) Filed: Dec. 5, 2012

(51) Int. Cl. B62B 5/06

(52) U.S. Cl. CPC B62B 5/06
USPC 280/47.31; 16/430

(57) ABSTRACT

A trolley handle is configured for placement upon a handle stock for a trolley or wheelbarrow and gripped by an operator for a transit grip to transport a load, a dump grip to dump a load, and a transition grip for transition between the transit and dump grips. The trolley handle includes: a closed loop handle housing; a first grip zone defined upon the closed loop handle housing at a first predetermined position, and configured to ergonomically aid an operator to transit a wheelbarrow load; a second grip zone defined upon the closed loop handle housing at a second predetermined position, and configured to ergonomically aid an operator to dump the wheelbarrow load; and a third grip zone defined upon the closed loop handle housing at a third predetermined position, and configured to ergonomically aid an operator to transition between the first grip zone and the second grip zone.

### FIELD OF THE INVENTION

The technology described herein relates generally to the fields of trolleys, wheelbarrows, handles for tools and implements, and the like. More specifically, this technology relates to an ergonomic trolley handle having an improved grip surface. Furthermore, this technology relates to an ergonomic trolley or wheelbarrow handle having unique calculated angles configured specifically for lifting and transporting a load, dumping a load, and for transitioning between the transporting-a-load and dumping-a-load positions.

### BACKGROUND OF THE INVENTION

Trolleys and wheelbarrows are well known in the art. Typically a wheelbarrow includes: a hopper or cart portion, in which to stow materials or items for transport; a frame assembly having two handle stocks or posts, with which to grip and lift the wheelbarrow for movement; a wheel, on which the wheelbarrow rolls; and legs or a stand on the frame assembly, on which the wheelbarrow is at rest when not in motion. The two handles or posts typically include two elongated handle portions coupled to the lower side of the hopper or cart portion. There are deficiencies and shortcomings with handles and handle grips known in the art.

Related design and utility patents, and related non-patent information, known in the art include the following:

U.S. Pat. No. D393,514, issued to Hadley et al. on Apr. 14, 1998, discloses the ornamental design for a wheelbarrow handle grip.

U.S. Pat. No. D595,470, issued to Albert et al. on Jun. 30, 2009, discloses the ornamental design for a handle for a wheelbarrow.

U.S. Pat. No. D638,192, issued to Hatcher et al. on May 17, 2011, discloses the ornamental design for a loop grip handle for wheelbarrows.

U.S. Pat. No. D646,042, issued to Hatcher et al. on Sep. 27, 2011, discloses the ornamental design for a loop grip handle for wheelbarrows.

U.S. Pat. No. 6,336,254, issued to Graff et al. on Jan. 8, 2002, discloses a curved handle adapted for attachment to a wheelbarrow or the like, and a method of manufacturing the same.

A wheelbarrow having handles, Ames True Temper Total Control 6 cubic foot poly wheelbarrow, is disclosed online on at least the date Aug. 23, 2012, at http://www.amestruetemper.com/products/detail.aspx?ProductId=1357&SubFamilyId=37&FamilyId=36&LineId=31.

The foregoing patent information reflects the state of the art of which the inventors are aware and is tendered with a view toward discharging the inventors' acknowledged duty of candor in disclosing information that may be pertinent to the patentability of the technology described herein. It is respectfully stipulated, however, that the foregoing patent and other information do not teach or render obvious, singly or when considered in combination, the inventors' claimed invention.

### BRIEF SUMMARY OF THE INVENTION

In various exemplary embodiments, the technology described herein provides an ergonomic trolley handle having unique calculated angles configured specifically for lifting and transporting a load, dumping a load, and for transitioning between the transporting-a-load and dumping-a-load positions.

In at least one exemplary embodiment, an ergonomic trolley handle configured for placement upon a handle stock for a trolley or wheelbarrow and gripped by an operator for a transit grip to transport a load, a dump grip to dump a load, and a transition grip for transition between the transit grip and the dump grip includes: a closed loop handle housing; a first grip zone defined upon the closed loop handle housing at a first predetermined position, and configured to ergonomically aid an operator to transit a wheelbarrow load; a second grip zone defined upon the closed loop handle housing at a second predetermined position, and configured to ergonomically aid an operator to dump the wheelbarrow load; and a third grip zone defined upon the closed loop handle housing at a third predetermined position, and configured to ergonomically aid an operator to transition between the first grip zone and the second grip zone.

It at least one embodiment of the ergonomic trolley handle, the first predetermined position consists of a transit angle defined relative to the closed loop handle housing, the transit angle defined between a first grip zone tangent line and a first grip zone apex tangent line that is parallel to a longitudinal axis of a handle stock.

It at least one embodiment of the ergonomic trolley handle, the second predetermined position consists of a dumping angle defined relative to the closed loop handle housing, the dumping angle defined between a second grip zone tangent line and an second grip zone antapex tangent line that is parallel to a longitudinal axis of a surface upon which the wheelbarrow is at rest.

It at least one embodiment of the ergonomic trolley handle, the third predetermined position consists of a transition angle defined relative to the closed loop handle housing, the transition angle defined between a third grip zone tangent line and a distal housing tangent line that is perpendicular to a longitudinal axis of a surface upon which the wheelbarrow is at rest.

It at least one embodiment of the ergonomic trolley handle, the transit angle defined between the first grip zone tangent line and the first grip zone apex tangent line that is parallel to the longitudinal axis of the handle stock is selected from a range between or equal to five degrees to fifteen degrees.

It at least one embodiment of the ergonomic trolley handle, the transit angle defined between the first grip zone tangent line and the first grip zone apex tangent line that is parallel to the longitudinal axis of the handle stock is approximately ten degrees.

It at least one embodiment of the ergonomic trolley handle, the dumping angle defined between the second grip zone tangent line and the second grip zone antapex tangent line that is parallel to the longitudinal axis of the surface upon which the wheelbarrow is at rest is selected from a range between or equal to twenty five degrees to thirty five degrees.

It at least one embodiment of the ergonomic trolley handle, the dumping angle defined between the second grip zone tangent line and the second grip zone antapex tangent line that is parallel to the longitudinal axis of the surface upon which the wheelbarrow is at rest is approximately thirty degrees.

It at least one embodiment of the ergonomic trolley handle, the transition angle defined between the third grip zone tangent line and the distal housing tangent line that is perpendicular to the longitudinal axis of the surface upon which the wheelbarrow is at rest is selected from a range between or equal to forty five degrees to fifty five degrees.

It at least one embodiment of the ergonomic trolley handle, the transition angle defined between the third grip zone tangent line and the distal housing tangent line that is perpendicular to the longitudinal axis of the surface upon which the wheelbarrow is at rest is approximately fifty degrees.

It at least one embodiment, the ergonomic trolley handle further includes: an engagement section for securing the trolley handle securely to the handle stock; and at least one fastening means to maintain the trolley handle securely to the handle stock.

It at least one embodiment of the ergonomic trolley handle, the closed loop handle housing, first grip zone, second grip zone, and third grip zone comprising the trolley handle are integrally formed and form a one-piece handle.

It at least one embodiment of the ergonomic trolley handle, the closed loop handle housing, first grip zone, second grip zone, and third grip zone comprising the trolley handle are plastic.

In at least one exemplary embodiment, a combined ergonomic trolley handle and handle stock includes: a handle stock for a trolley or wheelbarrow; a closed loop handle housing disposed upon the handle stock and configured for placement on a trolley or wheelbarrow and grip by an operator for a transit grip to transport a load, a dump grip to dump a load, and a transition grip for transition between the transit grip and the dump grip; a first grip zone defined upon the closed loop handle housing at a first predetermined position, and configured to ergonomically aid an operator to transit a wheelbarrow load; a second grip zone defined upon the closed loop handle housing at a second predetermined position, and configured to ergonomically aid an operator to dump the wheelbarrow load; and a third grip zone defined upon the closed loop handle housing at a third predetermined position, and configured to ergonomically aid an operator to transition between the first grip zone and the second grip zone.

It at least one embodiment of the combined ergonomic trolley handle and handle stock: the first predetermined position consists of a transit angle defined relative to the closed loop handle housing, the transit angle defined between a first grip zone tangent line and a first grip zone apex tangent line that is parallel to a longitudinal axis of a handle stock; the second predetermined position consists of a dumping angle defined relative to the closed loop handle housing, the dumping angle defined between a second grip zone tangent line and an second grip zone antapex tangent line that is parallel to a longitudinal axis of a surface upon which the wheelbarrow is at rest; and the third predetermined position consists of a transition angle defined relative to the closed loop handle housing, the transition angle defined between a third grip zone tangent line and a distal housing tangent line that is perpendicular to a longitudinal axis of a surface upon which the wheelbarrow is at rest.

It at least one embodiment of the combined ergonomic trolley handle and handle stock: the transit angle defined between the first grip zone tangent line and the first grip zone apex tangent line that is parallel to the longitudinal axis of the handle stock is selected from a range between or equal to five degrees to fifteen degrees; the dumping angle defined between the second grip zone tangent line and the second grip zone antapex tangent line that is parallel to the longitudinal axis of the surface upon which the wheelbarrow is at rest is selected from a range between or equal to twenty five degrees to thirty five degrees; and the transition angle defined between the third grip zone tangent line and the distal housing tangent line that is perpendicular to the longitudinal axis of the surface upon which the wheelbarrow is at rest is selected from a range between or equal to forty five degrees to fifty five degrees.

In at least one exemplary embodiment, a wheelbarrow having ergonomic trolley handles includes: a wheelbarrow; a pair of handle stocks disposed upon the wheelbarrow; a closed loop handle housing disposed upon each of the handle stocks and configured grip by an operator for a transit grip to transport a load, a dump grip to dump a load, and a transition grip for transition between the transit grip and the dump grip; a first grip zone defined upon the closed loop handle housing at a first predetermined position, and configured to ergonomically aid an operator to transit a wheelbarrow load; a second grip zone defined upon the closed loop handle housing at a second predetermined position, and configured to ergonomically aid an operator to dump the wheelbarrow load; and a third grip zone defined upon the closed loop handle housing at a third predetermined position, and configured to ergonomically aid an operator to transition between the first grip zone and the second grip zone.

In at least one embodiment of wheelbarrow having ergonomic trolley handles: the first predetermined position consists of a transit angle defined relative to the closed loop handle housing, the transit angle defined between a first grip zone tangent line and a first grip zone apex tangent line that is parallel to a longitudinal axis of a handle stock; the second predetermined position consists of a dumping angle defined relative to the closed loop handle housing, the dumping angle defined between a second grip zone tangent line and an second grip zone antapex tangent line that is parallel to a longitudinal axis of a surface upon which the wheelbarrow is at rest; and the third predetermined position consists of a transition angle defined relative to the closed loop handle housing, the transition angle defined between a third grip zone tangent line and a distal housing tangent line that is perpendicular to a longitudinal axis of a surface upon which the wheelbarrow is at rest.

In at least one embodiment of wheelbarrow having ergonomic trolley handles: the transit angle defined between the first grip zone tangent line and the first grip zone apex tangent line that is parallel to the longitudinal axis of the handle stock is selected from a range between or equal to five degrees to fifteen degrees; the dumping angle defined between the second grip zone tangent line and the second grip zone antapex tangent line that is parallel to the longitudinal axis of the surface upon which the wheelbarrow is at rest is selected from a range between or equal to twenty five degrees to thirty five degrees; and the transition angle defined between the third grip zone tangent line and the distal housing tangent line that is perpendicular to the longitudinal axis of the surface upon which the wheelbarrow is at rest is selected from a range between or equal to forty five degrees to fifty five degrees.

In at least one embodiment of wheelbarrow having ergonomic trolley handles: the transit angle defined between the first grip zone tangent line and the first grip zone apex tangent line that is parallel to the longitudinal axis of the handle stock is approximately ten degrees; the dumping angle defined between the second grip zone tangent line and the second grip zone antapex tangent line that is parallel to the longitudinal axis of the surface upon which the wheelbarrow is at rest is approximately thirty degrees; and the transition angle defined between the third grip zone tangent line and the distal housing tangent line that is perpendicular to the longitudinal axis of the surface upon which the wheelbarrow is at rest is approximately fifty degrees.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a front perspective view, generally from the top, of an ergonomic trolley handle, according to an embodiment of the technology described herein;

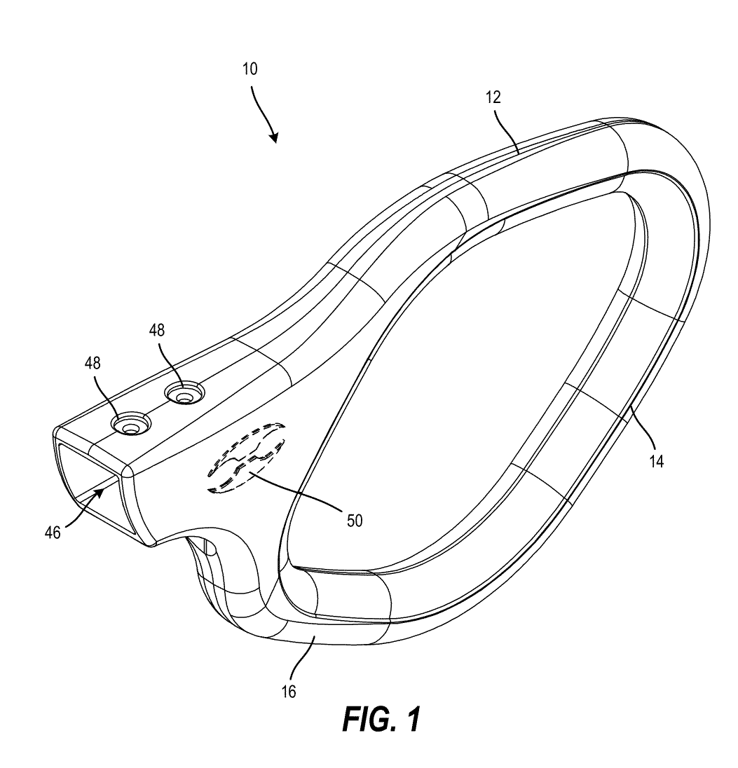

FIG. 2 is a second perspective view, generally from the bottom, of the ergonomic trolley handle depicted in FIG. 1;

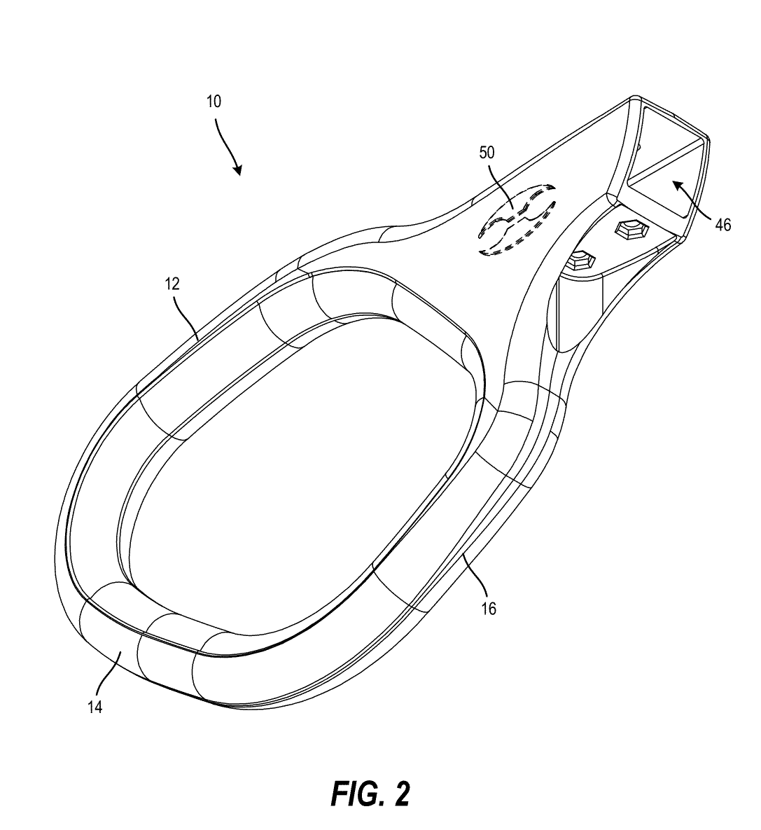

FIG. 3 is a first side view of the ergonomic trolley handle depicted in FIG. 1;

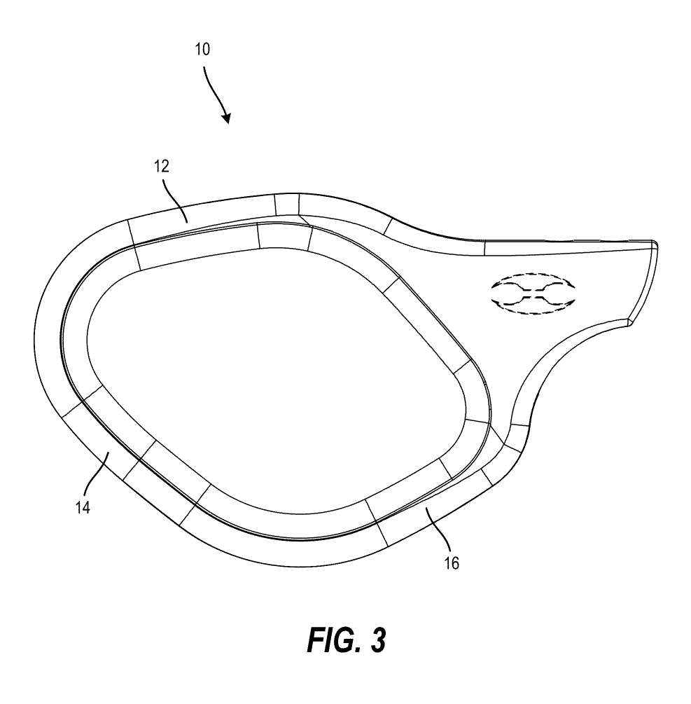

FIG. 4 is a second side view of the ergonomic trolley handle depicted in FIG. 1;

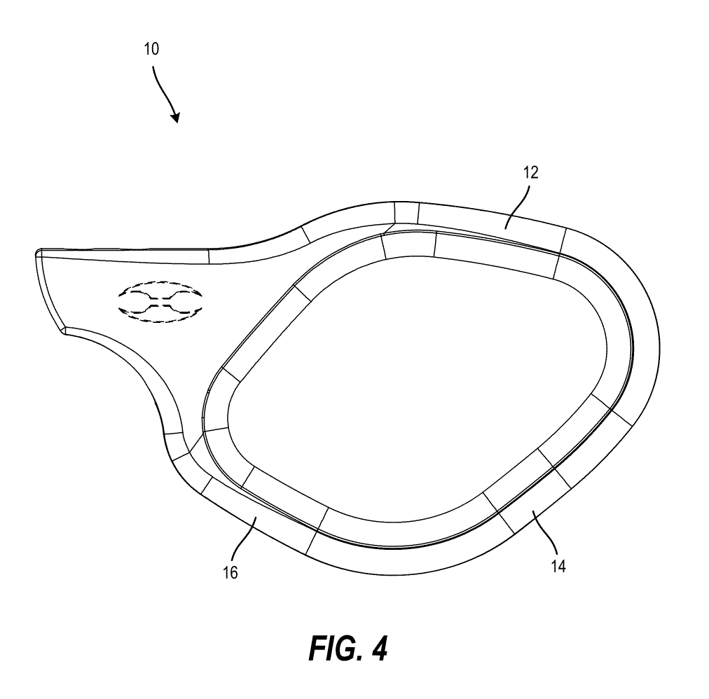

FIG. 5 is a top view of the ergonomic trolley handle depicted in FIG. 1;

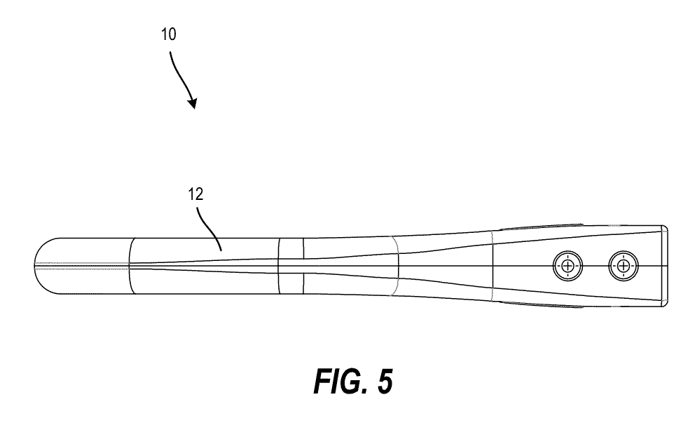

FIG. 6 is a bottom view of the ergonomic trolley handle depicted in FIG. 1;

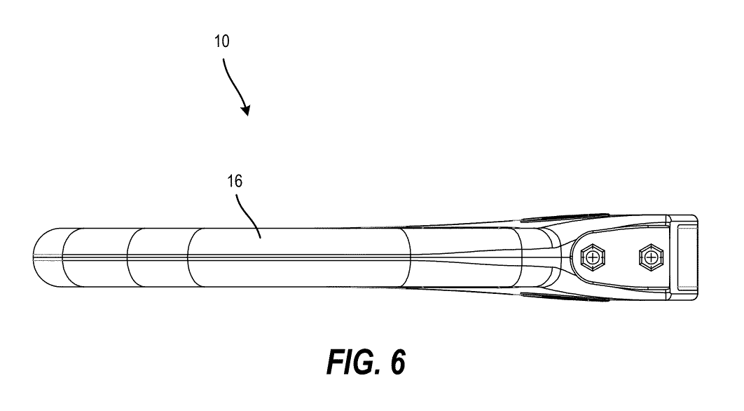

FIG. 7 is a first end view of the ergonomic trolley handle depicted in FIG. 1;

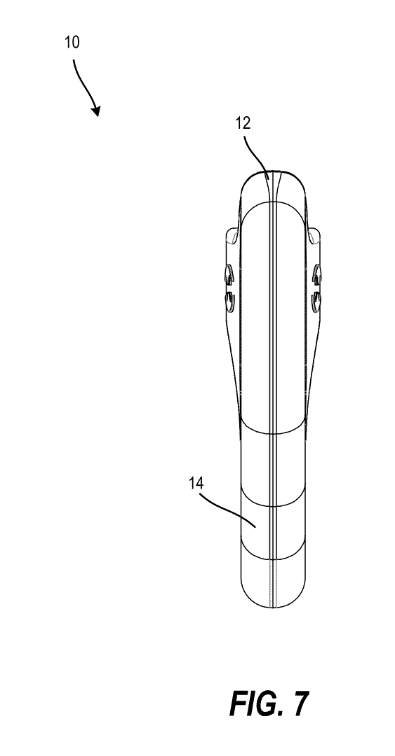

FIG. 8 is a second end view of the ergonomic trolley handle depicted in FIG. 1;

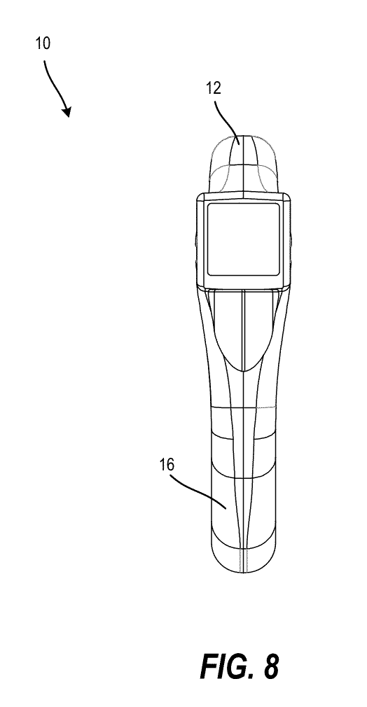

FIG. 9 is a side view of the ergonomic trolley handle depicted in FIG. 1, illustrating, in particular, three unique angles to enhance ergonomics in lifting and transporting a load, dumping a load, and for transitioning between the transporting-a-load and dumping-a-load positions;

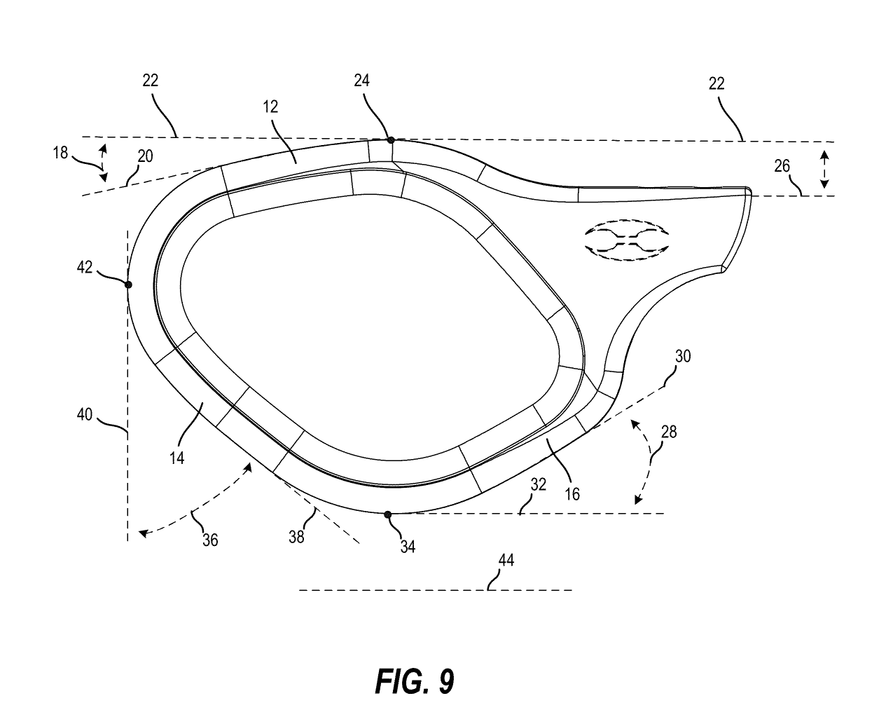

FIG. 10 is a perspective view of the ergonomic trolley handle depicted in FIG. 1, illustrating, in particular, use on a wheelbarrow in a position at rest, and an initial grip position by the operator, according to an embodiment of the technology described herein;

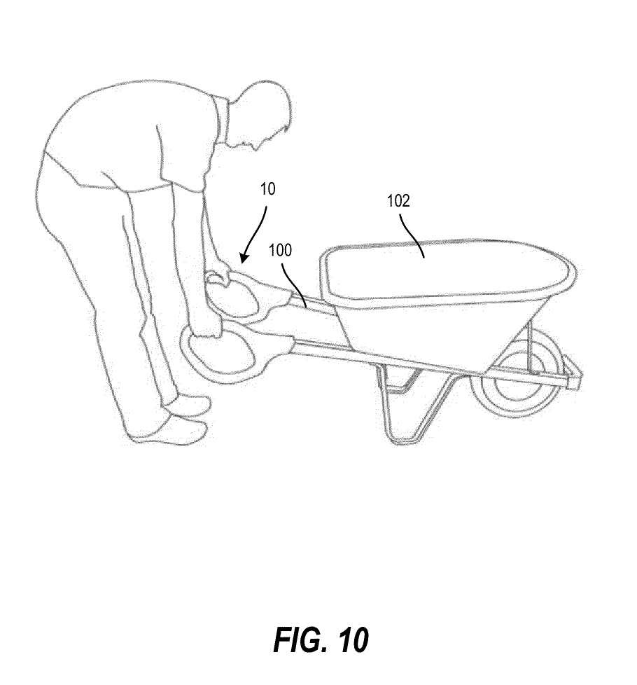

FIG. 11 is a perspective view of the ergonomic trolley handle depicted in FIG. 1, illustrating, in particular, use on a wheelbarrow in a position of transit, and a transit grip position by the operator, according to an embodiment of the technology described herein;

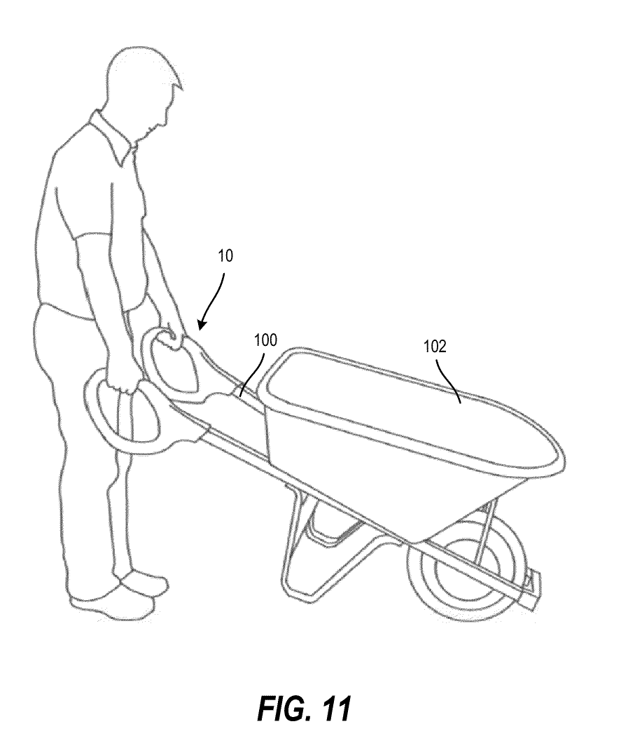

FIG. 12 is a perspective view of the ergonomic trolley handle depicted in FIG. 1, illustrating, in particular, use on a wheelbarrow in a transition position, and a transition grip position by the operator, according to an embodiment of the technology described herein; and

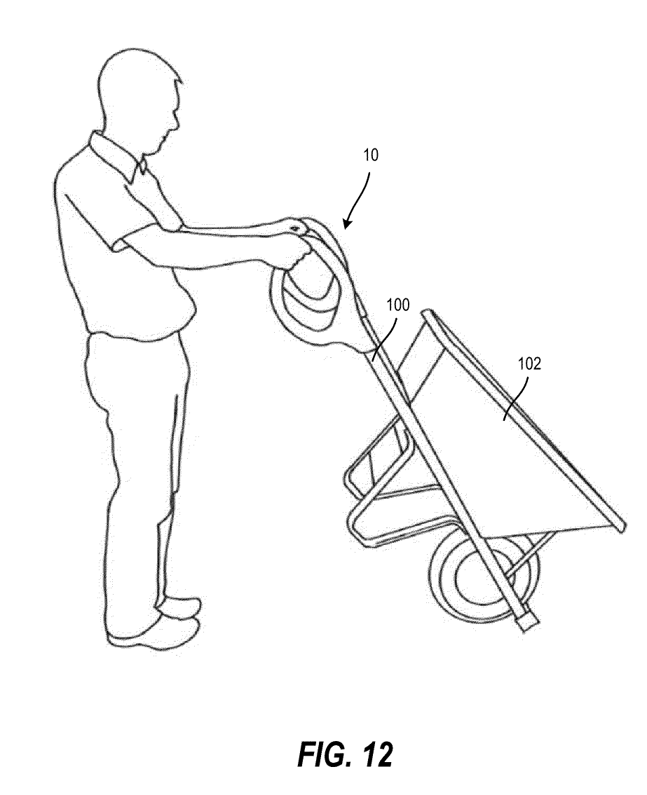

FIG. 13 is a perspective view of the ergonomic trolley handle depicted in FIG. 1, illustrating, in particular, use on a wheelbarrow in a dumping position, and a dumping grip position by the operator, according to an embodiment of the technology described herein.

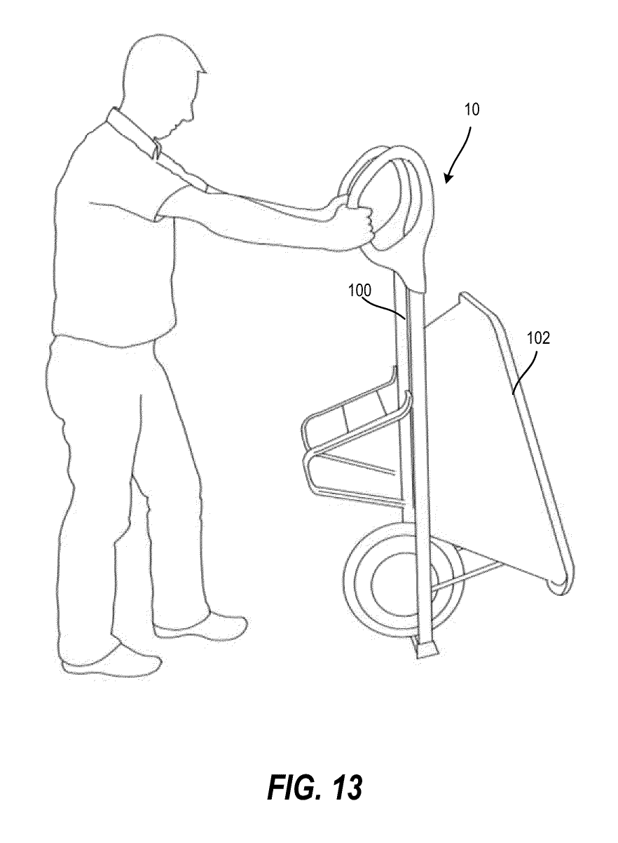

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides an ergonomic trolley handle having unique calculated angles configured specifically for lifting and transporting a load, dumping a load, and for transitioning between the transporting-a-load and dumping-a-load positions. The ergonomic trolley handle provides an operator an ergonomic solution to these tasks.

Referring now to the Figures, an ergonomic trolley handle 10 is shown. The ergonomic trolley handle 10 is configured for placement upon a handle stock 100 for a trolley or wheelbarrow 102 or the like. The ergonomic trolley handle 10 can be used on other likes devices where such an ergonomic handle 10 is appropriate. The ergonomic trolley handle 10 is configured for grip by an operator in a multiplicity of positions, dependent on the current need with the wheelbarrow 102, or like device. The ergonomic trolley handle 10 is configured for use by an operator to selectively use transit grip to transport a load, a dump grip to dump a load, and a transition grip for transition between the transit grip and the dump grip.

The ergonomic trolley handle 10 is a closed loop handle housing having a multiplicity of grip positions. At least three specific ergonomic grip zones 12, 14, 16 are disclosed herein, each aiding an operator in the use of completing tasks with a wheelbarrow 100 or like device.

The ergonomic trolley handle 10 includes a first grip zone 12 defined upon the closed loop handle housing at a first predetermined position. The first grip zone 12 is configured to ergonomically aid an operator to transit a wheelbarrow load. The first grip zone 12 has been found to provide an ideal ergonomic position for the operator while in use while in transit.

The ergonomic trolley handle 10 includes a second grip zone 14 defined upon the closed loop handle housing at a second predetermined position. The second grip zone 14 is configured to ergonomically aid an operator to dump the wheelbarrow load. The second grip zone 14 has been found to provide an ideal ergonomic position for the operator while in use dumping a load.

The ergonomic trolley handle 10 includes a third grip zone 16 defined upon the closed loop handle housing at a third predetermined position. The third grip zone 16 is configured to ergonomically aid an operator to transition between the first grip zone and the second grip zone. The third grip zone 16 has been found to provide an ideal ergonomic position for the operator while transitioning between transit of a load and dumping a load.

It at least one embodiment of the ergonomic trolley handle 10, first grip zone 12 is located a first predetermined position upon the closed loop handle housing. The first grip zone 12 location consists of a transit angle 18. The transit angle 18 is defined relative to the closed loop handle housing. The transit angle 18 is defined between a first grip zone tangent line 20 and a first grip zone apex tangent line 22, which is tangent to the first grip zone 12, crossing apex point 24, which is parallel to a longitudinal axis 26 of a handle stock 100. The first grip zone tangent line 20 and the first grip zone apex tangent line 22 intersect at apex point 24, and the transit angle 18 is defined therebetween.

It at least one embodiment of the ergonomic trolley handle 10, a second grip zone 16 is located at a second predetermined position upon the closed loop handle housing. The second grip zone location 16 consists of a dumping angle 28. The dumping angle 28 is defined relative to the closed loop handle housing. The transit angle 18 is defined between a second grip zone tangent line 30 and an second grip zone antapex tangent line 32, crossing antapex point 34, that is parallel to a longitudinal axis 44 of a surface upon which the wheelbarrow 102 is at rest. The dumping angle 28 is defined between the intersection of the second grip zone tangent line 30 and the second grip zone antapex tangent line 32.

It at least one embodiment of the ergonomic trolley handle 10, a third grip zone 14 is located at a third predetermined position upon the closed loop handle housing. The third grip zone location 14 consists of a transition angle 36. The transition angle 36 is defined relative to the closed loop handle housing. The transition angle 36 is defined between a third grip zone tangent line 38 and a distal housing tangent line 40, crossing distal housing point 42, that is perpendicular to a longitudinal axis 44 of a surface upon which the wheelbarrow is at rest. The transition angle 36 is defined between the intersection of the third grip zone tangent line 38 and the distal housing tangent line 40.

It at least one embodiment of the ergonomic trolley handle 10, the transit angle 18 defined between the first grip zone tangent line 20 and the first grip zone apex tangent line 22 that is parallel to the longitudinal axis 26 of the handle stock 100 is selected from a range between or equal to five degrees to fifteen degrees.

It at least one embodiment of the ergonomic trolley handle 10, the transit angle 18 defined between the first grip zone tangent line 20 and the first grip zone apex tangent line 20 that is parallel to the longitudinal axis 26 of the handle stock 100 is approximately ten degrees.

It at least one embodiment of the ergonomic trolley handle 10, the dumping angle 28 defined between the second grip zone tangent line 30 and the second grip zone antapex tangent line 32 that is parallel to the longitudinal axis 44 of the surface upon which the wheelbarrow 100 is at rest is selected from a range between or equal to twenty five degrees to thirty five degrees.

It at least one embodiment of the ergonomic trolley handle 10, the dumping angle 28 defined between the second grip zone tangent line 30 and the second grip zone antapex tangent line 32 that is parallel to the longitudinal axis 44 of the surface upon which the wheelbarrow 100 is at rest is approximately thirty degrees.

It at least one embodiment of the ergonomic trolley handle 10, the transition angle 36 defined between the third grip zone tangent line 38 and the distal housing tangent line 40 that is perpendicular to the longitudinal axis 44 of the surface upon which the wheelbarrow 100 is at rest is selected from a range between or equal to forty five degrees to fifty five degrees.

It at least one embodiment of the ergonomic trolley handle 10, the transition angle 36 defined between the third grip zone tangent line 38 and the distal housing tangent line 40 that is perpendicular to the longitudinal axis 44 of the surface upon which the wheelbarrow 100 is at rest is approximately fifty degrees.

It at least one embodiment, the ergonomic trolley handle 10 further includes an engagement section 46. The engagement section 46 is configured to secure the trolley handle 10 securely to the handle stock 100. The engagement section 46 includes at least one fastening means 48. The at least one fastening means 48 in configured to maintain the trolley handle 10 securely to the handle stock 100. The at least one fastening means 48 includes, by way of example and not of limitation, a bolt to secure the trolley handle 10 securely to the handle stock 100. Adhesives and glues also can be utilized to secure the trolley handle 10 securely to the handle stock 100.

It at least one embodiment of the ergonomic trolley handle 10, the closed loop handle housing, first grip zone 12, second grip zone 16, and third grip zone 18 comprising the trolley handle 10 are integrally formed and form a one-piece handle.

It at least one embodiment of the ergonomic trolley handle 10, the closed loop handle housing, first grip zone 12, second grip zone 16, and third grip zone 18 comprising the trolley handle 10 are plastic.

In various embodiments, the ergonomic trolley handle 10 can be manufactured and sold separately. Alternatively, the ergonomic trolley handle 10 can be manufactured combined with a handle stock 100 and sold as a combined unit. Alternatively, the ergonomic trolley handle 10 can be manufactured and sold combined with a wheelbarrow, trolley, or the like.

In at least one embodiment, the ergonomic trolley handle 10 further includes a logo or identification section 50.

In use, the ergonomic trolley handle 10 provides an operator with an ergonomic solution for use of a wheelbarrow or like device. The ergonomic trolley handle 10 provides for lifting and transporting a load in a wheelbarrow, dumping a load from a wheelbarrow, and for transitioning between the transporting-a-load and dumping-a-load positions. The ergonomic trolley handle 10 provides an operator an ergonomic solution to all of these tasks.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. An ergonomic trolley handle configured for placement upon a handle stock for a trolley or wheelbarrow and gripped by an operator for a transit grip to transport a load, a dump grip to dump a load, and a transition grip for transition between the transit grip and the dump grip, the trolley handle comprising:
a closed loop handle housing;
a first grip zone defined upon the closed loop handle housing at a first predetermined position, and configured to ergonomically aid an operator to transit a wheelbarrow load;
a second grip zone defined upon the closed loop handle housing at a second predetermined position, and configured to ergonomically aid an operator to dump the wheelbarrow load; and
a third grip zone defined upon the closed loop handle housing at a third predetermined position, and configured to ergonomically aid an operator to transition between the first grip zone and the second grip zone.

2. The ergonomic trolley handle of claim 1, wherein the first predetermined position consists of a transit angle defined relative to the closed loop handle housing, the transit angle defined between a first grip zone tangent line and a first grip zone apex tangent line that is parallel to a longitudinal axis of a handle stock.

3. The ergonomic trolley handle of claim 1, wherein the second predetermined position consists of a dumping angle defined relative to the closed loop handle housing, the dumping angle defined between a second grip zone tangent line and an second grip zone antapex tangent line that is parallel to a longitudinal axis of a surface upon which the wheelbarrow is at rest.

4. The ergonomic trolley handle of claim 1, wherein the third predetermined position consists of a transition angle defined relative to the closed loop handle housing, the transition angle defined between a third grip zone tangent line and a distal housing tangent line that is perpendicular to a longitudinal axis of a surface upon which the wheelbarrow is at rest.

5. The ergonomic trolley handle of claim 2, wherein the transit angle defined between the first grip zone tangent line and the first grip zone apex tangent line that is parallel to the longitudinal axis of the handle stock is selected from a range between or equal to five degrees to fifteen degrees.

6. The ergonomic trolley handle of claim 2, wherein the transit angle defined between the first grip zone tangent line and the first grip zone apex tangent line that is parallel to the longitudinal axis of the handle stock is approximately ten degrees.

7. The ergonomic trolley handle of claim 3, wherein the dumping angle defined between the second grip zone tangent line and the second grip zone antapex tangent line that is parallel to the longitudinal axis of the surface upon which the wheelbarrow is at rest is selected from a range between or equal to twenty five degrees to thirty five degrees.

8. The ergonomic trolley handle of claim 3, wherein the dumping angle defined between the second grip zone tangent line and the second grip zone antapex tangent line that is parallel to the longitudinal axis of the surface upon which the wheelbarrow is at rest is approximately thirty degrees.

9. The ergonomic trolley handle of claim 4, wherein the transition angle defined between the third grip zone tangent line and the distal housing tangent line that is perpendicular to the longitudinal axis of the surface upon which the wheelbarrow is at rest is selected from a range between or equal to forty five degrees to fifty five degrees.

10. The ergonomic trolley handle of claim 4, wherein the transition angle defined between the third grip zone tangent line and the distal housing tangent line that is perpendicular to the longitudinal axis of the surface upon which the wheelbarrow is at rest is approximately fifty degrees.

11. The ergonomic trolley handle of claim 1, further comprising:
an engagement section for securing the trolley handle securely to the handle stock; and
at least one fastening means to maintain the trolley handle securely to the handle stock.

12. The ergonomic trolley handle of claim 1, wherein the closed loop handle housing, first grip zone, second grip zone, and third grip zone comprising the trolley handle are integrally formed and form a one-piece handle.

13. The ergonomic trolley handle of claim 1, wherein the closed loop handle housing, first grip zone, second grip zone, and third grip zone comprising the trolley handle are plastic.

14. A combined ergonomic trolley handle and handle stock comprising:
a handle stock for a trolley or wheelbarrow;
a closed loop handle housing disposed upon the handle stock and configured for placement on a trolley or wheelbarrow and grip by an operator for a transit grip to transport a load, a dump grip to dump a load, and a transition grip for transition between the transit grip and the dump grip;
a first grip zone defined upon the closed loop handle housing at a first predetermined position, and configured to ergonomically aid an operator to transit a wheelbarrow load;
a second grip zone defined upon the closed loop handle housing at a second predetermined position, and configured to ergonomically aid an operator to dump the wheelbarrow load; and
a third grip zone defined upon the closed loop handle housing at a third predetermined position, and configured to ergonomically aid an operator to transition between the first grip zone and the second grip zone.

15. The combined ergonomic trolley handle and handle stock of claim 14,
wherein the first predetermined position consists of a transit angle defined relative to the closed loop handle housing, the transit angle defined between a first grip zone tangent line and a first grip zone apex tangent line that is parallel to a longitudinal axis of a handle stock;
wherein the second predetermined position consists of a dumping angle defined relative to the closed loop handle housing, the dumping angle defined between a second grip zone tangent line and an second grip zone antapex tangent line that is parallel to a longitudinal axis of a surface upon which the wheelbarrow is at rest; and
wherein the third predetermined position consists of a transition angle defined relative to the closed loop handle housing, the transition angle defined between a third grip zone tangent line and a distal housing tangent line that is perpendicular to a longitudinal axis of a surface upon which the wheelbarrow is at rest.

16. The combined ergonomic trolley handle and handle stock of claim 14,
wherein the transit angle defined between the first grip zone tangent line and the first grip zone apex tangent line that is parallel to the longitudinal axis of the handle stock is selected from a range between or equal to five degrees to fifteen degrees;
wherein the dumping angle defined between the second grip zone tangent line and the second grip zone antapex tangent line that is parallel to the longitudinal axis of the surface upon which the wheelbarrow is at rest is selected from a range between or equal to twenty five degrees to thirty five degrees; and
wherein the transition angle defined between the third grip zone tangent line and the distal housing tangent line that is perpendicular to the longitudinal axis of the surface upon which the wheelbarrow is at rest is selected from a range between or equal to forty five degrees to fifty five degrees.

17. A wheelbarrow having ergonomic trolley handles comprising:
a wheelbarrow;
a pair of handle stocks disposed upon the wheelbarrow;
a closed loop handle housing disposed upon each of the handle stocks and configured grip by an operator for a transit grip to transport a load, a dump grip to dump a load, and a transition grip for transition between the transit grip and the dump grip;
a first grip zone defined upon the closed loop handle housing at a first predetermined position, and configured to ergonomically aid an operator to transit a wheelbarrow load;
a second grip zone defined upon the closed loop handle housing at a second predetermined position, and configured to ergonomically aid an operator to dump the wheelbarrow load; and
a third grip zone defined upon the closed loop handle housing at a third predetermined position, and configured to ergonomically aid an operator to transition between the first grip zone and the second grip zone.

18. The wheelbarrow having ergonomic trolley handles of claim 17,
wherein the first predetermined position consists of a transit angle defined relative to the closed loop handle housing, the transit angle defined between a first grip zone tangent line and a first grip zone apex tangent line that is parallel to a longitudinal axis of a handle stock;
wherein the second predetermined position consists of a dumping angle defined relative to the closed loop handle housing, the dumping angle defined between a second grip zone tangent line and an second grip zone antapex tangent line that is parallel to a longitudinal axis of a surface upon which the wheelbarrow is at rest; and
wherein the third predetermined position consists of a transition angle defined relative to the closed loop handle housing, the transition angle defined between a third grip zone tangent line and a distal housing tangent line that is perpendicular to a longitudinal axis of a surface upon which the wheelbarrow is at rest.

19. The wheelbarrow having ergonomic trolley handles of claim 18,
wherein the transit angle defined between the first grip zone tangent line and the first grip zone apex tangent line that is parallel to the longitudinal axis of the handle stock is selected from a range between or equal to five degrees to fifteen degrees;
wherein the dumping angle defined between the second grip zone tangent line and the second grip zone antapex tangent line that is parallel to the longitudinal axis of the surface upon which the wheelbarrow is at rest is selected from a range between or equal to twenty five degrees to thirty five degrees; and
wherein the transition angle defined between the third grip zone tangent line and the distal housing tangent line that is perpendicular to the longitudinal axis of the surface upon which the wheelbarrow is at rest is selected from a range between or equal to forty five degrees to fifty five degrees.

20. The wheelbarrow having ergonomic trolley handles of claim 18,
wherein the transit angle defined between the first grip zone tangent line and the first grip zone apex tangent line that is parallel to the longitudinal axis of the handle stock is approximately ten degrees;
wherein the dumping angle defined between the second grip zone tangent line and the second grip zone antapex tangent line that is parallel to the longitudinal axis of the surface upon which the wheelbarrow is at rest is approximately thirty degrees; and
wherein the transition angle defined between the third grip zone tangent line and the distal housing tangent line that is perpendicular to the longitudinal axis of the surface upon which the wheelbarrow is at rest is approximately fifty degrees.
